(19) United States
(12) Patent Application Publication
(10) Pub. No.: US 2023/0363383 A1
(43) Pub. Date: Nov. 16, 2023

(54) COMBINATIONS OF CHLOROACETANILIDE HERBICIDES WITH SAFENERS

(71) Applicants: UPL DO BRASIL INDUSTRIA E COMERCIO DE INSUMOS AGROPECUARIOS S.A., Ituverava (BR); UPL Corporation Limited, Port Louis (MU)

(72) Inventors: Giuvan Lenz, Ituverava (BR); Ferdinando Marcos Lima Silva, Ituverava (BR)

(21) Appl. No.: 18/028,661

(22) PCT Filed: Sep. 27, 2021
(86) PCT No.: PCT/BR2021/050413

§ 371 Date: Mar. 27, 2023

(30) Foreign Application Priority Data
Sep. 28, 2020 (BR) BR102020019866-1

(51) Int. Cl. A01N 25/32; A01N 43/56

(52) U.S. Cl. CPC A01N 25/32; A01N 43/56

(57) ABSTRACT

The present invention relates to a combination for the selective control of weeds. More particularly, the present invention relates to a combination of one or more chloroacetanilide herbicides with one or more safeners for the selective control of weeds.

### FIELD OF THE INVENTION

The present invention relates to a combination for the selective control of weeds. More particularly, the present invention relates to a combination of one or more chloroacetanilide herbicides with one or more safeners for the selective control of weeds.

### BACKGROUND OF THE INVENTION

Some very effective herbicides i.e. herbicides that exhibit highly effective weed control exhibit toxicity on the crop itself along with weeds. In other words, they exhibit non selective control of weeds to be eliminated. This is also the case with Chloroacetanilide herbicides such as Propisochlor, S-metolachlor and Metolachlor that exhibit excellent weed control but at the cost of damage to crop itself. Sometimes this undesired effect on the crop can be so devastating that whole crop gets wiped out. In such cases, phytotoxicity is said to be 100%. Other instances of unwanted effects of herbicides on crops are lesser plant height or lesser number of plants standing after herbicidal treatments.

Propisochlor, S-metolachlor and Metolachlor act by inhibition of VLCFA. VLCFA (very long chain fatty acids) inhibitors cause preventing of emergence of shoot from the coleoptile or whorl of the grass and cause enlarged cotyledons, restricted growth of the true leaves, dark green color, and stunting of broadleaf plants.

IUPAC name of Propisochlor is 2-chloro-2′-ethyl-N-(isopropoxymethyl)-6′-methylacetanilide.

IUPAC name of S-metolachlor is mixture of (aRS,1S)-2-chloro-6′-ethyl-N-(2-methoxy-1-methylethyl)acet-o-toluidide and (aRS,1R)-2-chloro-6′-ethyl-N-(2-methoxy-1-methylethyl)acet-o-toluidide.

IUPAC name of Metolachlor is 2-chloro-2′-ethyl-N-[(1RS)-2-methoxy-1-methylethyl]-6′-methylacetanilide.

Chemical agents called as safeners, when used with herbicides, act as their antidotes and make use of the herbicides safer. However, it is pertinent to note that not all the safeners work well with all the herbicides. Scientists are always faced with the challenge of finding safener herbicide combinations that work well.

There is therefore a need in the art for safener combinations with Chloroacetanilide herbicides that reduce their phytotoxicity, result in increased plant height and/or increased number of plants standing after herbicidal treatment.

### Objects of the Invention

The present invention, described hereinafter, achieves at least one of the following objects of the invention.

It is an object of the present invention to provide combinations of one or more chloroacetanilide herbicides with one or more safeners.

It is an object of the present invention to provide combinations of chloroacetanilide herbicides with one or more safeners, wherein chloroacetanilide herbicides are selected from one or more of Propisochlor, S-metolachlor and Metolachlor.

It is an object of the present invention to provide combinations of chloroacetanilide herbicides with one or more safeners, wherein chloroacetanilide herbicides are selected from one or more of Propisochlor, S-metolachlor and Metolachlor and said combinations exhibit less or no phytotoxicity.

It is an object of the present invention to provide combinations of chloroacetanilide herbicides with one or more safeners, wherein chloroacetanilide herbicides are selected from one or more of Propisochlor, S-metolachlor and Metolachlor and said combinations result in increased plant height.

It is an object of the present invention to provide combinations of chloroacetanilide herbicides with one or more safeners, wherein chloroacetanilide herbicides are selected from one or more of Propisochlor, S-metolachlor and Metolachlor and said combinations result in increased number of plants standing after treatment.

It is an object of the present invention to provide combinations of chloroacetanilide herbicides with one or more safeners, wherein chloroacetanilide herbicides are selected from one or more of Propisochlor, S-metolachlor and Metolachlor and said combinations exhibit less or no phytotoxicity, result in increased plant height and/or increased number of plants standing after treatment, preferably in corn, wheat, barley, rye, oats, rice, soybean, cotton, canola, sugar beet, potatoes, tobacco, and oil seed rape, more preferably in wheat.

It is an object of the present invention to provide a method of controlling weeds wherein one or more safeners are applied to seeds, from which crops are grown and Chloroacetanilide herbicides selected from one or more of Propisochlor, S-metolachlor and Metolachlor are later applied to the soil or grown crops.

### SUMMARY OF THE INVENTION

In an aspect, present invention provides combinations of one or more Chloroacetanilide herbicides with one or more safeners.

In an aspect, present invention provides combinations of one or more Chloroacetanilide herbicides with one or more safeners, wherein Chloroacetanilide herbicides are selected from one or more of Propisochlor, S-metolachlor and Metolachlor.

In an aspect, present invention provides combinations of Chloroacetanilide herbicides with one or more safeners, wherein Chloroacetanilide herbicides are selected from one or more of Propisochlor, S-metolachlor and Metolachlor and said combinations exhibit less or no phytotoxicity.

In an aspect, present invention provides combinations of Chloroacetanilide herbicides with one or more safeners, wherein Chloroacetanilide herbicides are selected from one or more of Propisochlor, S-metolachlor and Metolachlor and said combinations result in increased plant height.

In an aspect, present invention provides combinations of Chloroacetanilide herbicides with one or more safeners, wherein Chloroacetanilide herbicides are selected from one or more of Propisochlor, S-metolachlor and Metolachlor and said combinations result in increased number of plants standing after treatment.

In an aspect, present invention provides combinations of Chloroacetanilide herbicides with one or more safeners, wherein Chloroacetanilide herbicides are selected from one or more of Propisochlor, S-metolachlor and Metolachlor and said combinations exhibit less or no phytotoxicity, result in increased plant height and/or increased number of plants standing after treatment, preferably in corn, wheat, barley, rye, oats, rice, soybean, cotton, canola, sugar beet, potatoes, tobacco, and oil seed rape, more preferably in wheat.

In an aspect, present invention provides combinations of one or more Chloroacetanilide herbicides with safeners wherein safeners are selected from one or more of Mefenpyr-diethyl, Isoxadifen-ethyl, Cloquintocet-mexyl, Benoxacor, Flurazole and Fluxofenim.

In an aspect, present invention provides combinations of Chloroacetanilide herbicides with one or more safeners wherein Chloroacetanilide herbicides are selected from one or more of Propisochlor, S-metolachlor and Metolachlor and said combinations are applied preferably to corn, wheat, barley, rye, oats, rice, soybean, cotton, canola, sugar beet, potatoes, tobacco, and oil seed rape, more preferably to wheat.

In an aspect, present invention provides combinations of one or more Chloroacetanilide herbicides with one or more safeners selected from Mefenpyr-diethyl, Isoxadifen-ethyl, Cloquintocet-mexyl, Benoxacor, Flurazole and Fluxofenim and said combinations are applied preferably to corn, wheat, barley, rye, oats, rice, soybean, cotton, canola, sugar beet, potatoes, tobacco, and oil seed rape, more preferably to wheat.

In an aspect, present invention provides combinations of Propisochlor and one or more safeners selected from Mefenpyr-diethyl, Isoxadifen-ethyl, Cloquintocet-mexyl, Benoxacor, Flurazole and Fluxofenim.

In an aspect, present invention provides combinations of Propisochlor and one or more safeners selected from Mefenpyr-diethyl, Isoxadifen-ethyl, Cloquintocet-mexyl, Benoxacor, Flurazole and Fluxofenim and said combinations are applied preferably to corn, wheat, barley, rye, oats, rice, soybean, cotton, canola, sugar beet, potatoes, tobacco, and oil seed rape, more preferably to wheat.

In an aspect, present invention provides a method of controlling weeds, wherein one or more safeners selected from Mefenpyr-diethyl, Isoxadifen-ethyl, Dichlormid, Fenclorim, Cloquintocet-mexyl, Benoxacor, Flurazole and Fluxofenim are applied preferably to seeds of corn, wheat, barley, rye, oats, rice, soybean, cotton, canola, sugar beet, potatoes, tobacco, and oil seed rape, more preferably to seeds of wheat, from which crops are grown and Chloroacetanilide herbicides selected from one or more of Propisochlor, S-metolachlor and Metolachlor are later applied to the soil or grown crops.

In an aspect, present invention provides a method of controlling weeds, wherein one or more safeners selected from Mefenpyr-diethyl, Isoxadifen-ethyl, Dichlormid, Fenclorim, Cloquintocet-mexyl, Benoxacor, Flurazole and Fluxofenim are applied preferably to seeds of corn, wheat, barley, rye, oats, rice, soybean, cotton, canola, sugar beet, potatoes, tobacco, and oil seed rape, more preferably to seeds of wheat, from which crops are grown and Propisochlor is later applied to the soil or grown crops.

### DETAILED DESCRIPTION OF INVENTION

As used herein, the term “control” includes controlling a pest, i.e. killing, also protecting a plant, or seed from attack or invasion by said pest.

It has surprisingly been found by the present inventors that combination of one or more Chloroacetanilide herbicides with one or more safeners selectively controls weeds. Selective weed control was also accompanied by increased plant growth and increased number of plants standing after treatments. Treatments with one or more Chloroacetanilide herbicides alone resulted in phytotoxicity, lesser plant height and lesser number of plants standing after treatments. Selective weed control, increased plant growth and increased number of plants stranding after treatments with combination of one or more Chloroacetanilide herbicides with one or more safeners were unexpected. These unexpected results were also found when safeners were applied to seeds from which crops were grown and one or more Chloroacetanilide herbicides were later applied to the soil or grown crops.

In one embodiment, present invention provides combinations of one or more Chloroacetanilide herbicides with one or more safeners.

In another embodiment, present invention provides combinations of one or more Chloroacetanilide herbicides with one or more safeners, wherein Chloroacetanilide herbicides are selected from one or more of Propisochlor, S-metolachlor and Metolachlor.

In still another embodiment, present invention provides combinations of Chloroacetanilide herbicides with one or more safeners, wherein Chloroacetanilide herbicides are selected from one or more of Propisochlor, S-metolachlor and Metolachlor and said combinations exhibit less or no phytotoxicity.

In still another embodiment, present invention provides combinations of Chloroacetanilide herbicides with one or more safeners, wherein Chloroacetanilide herbicides are selected from one or more of Propisochlor, S-metolachlor and Metolachlor and said combinations result in increased plant height.

In still another embodiment, present invention provides combinations of Chloroacetanilide herbicides with one or more safeners, wherein Chloroacetanilide herbicides are selected from one or more of Propisochlor, S-metolachlor and Metolachlor and said combinations result in increased number of plants standing after herbicidal treatments.

In still another embodiment, present invention provides combinations of Chloroacetanilide herbicides with one or more safeners, wherein Chloroacetanilide herbicides are selected from one or more of Propisochlor, S-metolachlor and Metolachlor and said combinations exhibit less or no phytotoxicity, result in increased plant height and/or increased number of plants standing after herbicidal treatments, preferably in corn, wheat, barley, rye, oats, rice, soybean, cotton, canola, sugar beet, potatoes, tobacco, and oil seed rape, more preferably in wheat.

In still another embodiment, present invention provides combinations of one or more Chloroacetanilide herbicides with safeners wherein safeners are selected from one or more of Mefenpyr-diethyl, Isoxadifen-ethyl, Cloquintocet-mexyl, Benoxacor, Flurazole and Fluxofenim.

In still another embodiment, present invention provides combinations of Chloroacetanilide herbicides with one or more safeners wherein Chloroacetanilide herbicides are selected from one or more of Propisochlor, S-metolachlor and Metolachlor and said combinations are applied preferably to corn, wheat, barley, rye, oats, rice, soybean, cotton, canola, sugar beet, potatoes, tobacco, and oil seed rape, more preferably to wheat.

In still another embodiment, present invention provides combinations of one or more Chloroacetanilide herbicides with one or more safeners selected from Mefenpyr-diethyl, Isoxadifen-ethyl, Cloquintocet-mexyl, Benoxacor, Flurazole and Fluxofenim and said combinations are applied preferably to corn, wheat, barley, rye, oats, rice, soybean, cotton, canola, sugar beet, potatoes, tobacco, and oil seed rape, more preferably to wheat.

In still another embodiment, present invention provides combinations of Propisochlor and one or more safeners selected from Mefenpyr-diethyl, Isoxadifen-ethyl, Cloquintocet-mexyl, Benoxacor, Flurazole and Fluxofenim and said combinations are applied preferably to corn, wheat, barley, rye, oats, rice, soybean, cotton, canola, sugar beet, potatoes, tobacco, and oil seed rape, more preferably to wheat.

In still another embodiment, present invention provides combination of Propisochlor and Mefenpyr-diethyl and said combination exhibits less or no phytotoxicity, results in increased plant height and/or increased number of plants standing after treatment, preferably in corn, wheat, barley, rye, oats, rice, soybean, cotton, canola, sugar beet, potatoes, tobacco, and oil seed rape, more preferably in wheat.

In still another embodiment, present invention provides combination of Propisochlor and Isoxadifen-ethyl and said combination exhibits less or no phytotoxicity, results in increased plant height and/or increased number of plants standing after treatment, preferably in corn, wheat, barley, rye, oats, rice, soybean, cotton, canola, sugar beet, potatoes, tobacco, and oil seed rape, more preferably in wheat.

In still another embodiment, present invention provides combination of Propisochlor and Cloquintocet-mexyl and said combination exhibits less or no phytotoxicity, results in increased plant height and/or increased number of plants standing after treatment, preferably in corn, wheat, barley, rye, oats, rice, soybean, cotton, canola, sugar beet, potatoes, tobacco, and oil seed rape, more preferably in wheat.

In still another embodiment, present invention provides combination of Propisochlor and Benoxacor and said combination exhibits less or no phytotoxicity, results in increased plant height and/or increased number of plants standing after treatment, preferably in corn, wheat, barley, rye, oats, rice, soybean, cotton, canola, sugar beet, potatoes, tobacco, and oil seed rape, more preferably in wheat.

In still another embodiment, present invention provides combination of Propisochlor and Flurazole and said combination exhibits less or no phytotoxicity, results in increased plant height and/or increased number of plants standing after treatment, preferably in corn, wheat, barley, rye, oats, rice, soybean, cotton, canola, sugar beet, potatoes, tobacco, and oil seed rape, more preferably in wheat.

In still another embodiment, present invention provides combination of Propisochlor and Fluxofenim and said combination exhibits less or no phytotoxicity, results in increased plant height and/or increased number of plants standing after treatment, preferably in corn, wheat, barley, rye, oats, rice, soybean, cotton, canola, sugar beet, potatoes, tobacco, and oil seed rape, more preferably in wheat.

In still another embodiment, present invention provides combination of Propisochlor and Mefenpyr-diethyl, wherein ratio of Propisochlor to Mefenpyr-diethyl is from 6.4:1 to 64:1 and said combination exhibits less or no phytotoxicity, results in increased plant height and/or increased number of plants standing after treatment, preferably in corn, wheat, barley, rye, oats, rice, soybean, cotton, canola, sugar beet, potatoes, tobacco, and oil seed rape, more preferably in wheat.

In still another embodiment, present invention provides combination of Propisochlor and Isoxadifen-ethyl, wherein ratio of Propisochlor to Isoxadifen-ethyl is from 4.14:1 to 41.14:1 and said combination exhibits less or no phytotoxicity, results in increased plant height and/or increased number of plants standing after treatment, preferably in corn, wheat, barley, rye, oats, rice, soybean, cotton, canola, sugar beet, potatoes, tobacco, and oil seed rape, more preferably in wheat.

In still another embodiment, present invention provides combination of Propisochlor and Cloquintocet-mexyl, wherein ratio of Propisochlor to Cloquintocet-mexyl is from 14.4:1 to 144:1 and said combination exhibits less or no phytotoxicity, results in increased plant height and/or increased number of plants standing after treatment, preferably in corn, wheat, barley, rye, oats, rice, soybean, cotton, canola, sugar beet, potatoes, tobacco, and oil seed rape, more preferably in wheat.

In still another embodiment, present invention provides combination of Propisochlor and Benoxacor, wherein ratio of Propisochlor to Benoxacor is from 9.6:1 to 19.2:1 and said combination exhibits less or no phytotoxicity, results in increased plant height and/or increased number of plants standing after treatment, preferably in corn, wheat, barley, rye, oats, rice, soybean, cotton, canola, sugar beet, potatoes, tobacco, and oil seed rape, more preferably in wheat.

In still another embodiment, present invention provides combination of Propisochlor and Flurazole, wherein ratio of Propisochlor to Flurazole is from 24:1 to 240:1 and said combination exhibits less or no phytotoxicity, results in increased plant height and/or increased number of plants standing after treatment, preferably in corn, wheat, barley, rye, oats, rice, soybean, cotton, canola, sugar beet, potatoes, tobacco, and oil seed rape, more preferably in wheat.

In still another embodiment, present invention provides combination of Propisochlor and Fluxofenim, wherein ratio of Propisochlor to Fluxofenim is from 23.84:1 to 250.43:1 and said combination exhibits less or no phytotoxicity, results in increased plant height and/or increased number of plants standing after treatment, preferably in corn, wheat, barley, rye, oats, rice, soybean, cotton, canola, sugar beet, potatoes, tobacco, and oil seed rape, more preferably in wheat.

In still another embodiment, present invention provides combination of Propisochlor and Mefenpyr-diethyl, wherein Propisochlor and Mefenpyr-diethyl are applied preferably to corn, wheat, barley, rye, oats, rice, soybean, cotton, canola, sugar beet, potatoes, tobacco, and oil seed rape, more preferably to wheat, simultaneously or sequentially.

In still another embodiment, present invention provides combination of Propisochlor and Isoxadifen-ethyl, wherein Propisochlor and Isoxadifen-ethyl are applied preferably to corn, wheat, barley, rye, oats, rice, soybean, cotton, canola, sugar beet, potatoes, tobacco, and oil seed rape, more preferably to wheat, simultaneously or sequentially.

In still another embodiment, present invention provides combination of Propisochlor and Cloquintocet-mexyl, wherein Propisochlor and Cloquintocet-mexyl are applied preferably to corn, wheat, barley, rye, oats, rice, soybean, cotton, canola, sugar beet, potatoes, tobacco, and oil seed rape, more preferably to wheat, simultaneously or sequentially.

In still another embodiment, present invention provides combination of Propisochlor and Benoxacor, wherein Propisochlor and Benoxacor are applied preferably to corn, wheat, barley, rye, oats, rice, soybean, cotton, canola, sugar beet, potatoes, tobacco, and oil seed rape, more preferably to wheat, simultaneously or sequentially.

In still another embodiment, present invention provides combination of Propisochlor and Flurazole wherein Propisochlor and Flurazole are applied preferably to corn, wheat, barley, rye, oats, rice, soybean, cotton, canola, sugar beet, potatoes, tobacco, and oil seed rape, more preferably to wheat, simultaneously or sequentially.

In still another embodiment, present invention provides combination of Propisochlor and Fluxofenim wherein Propisochlor and Fluxofenim are applied preferably to corn, wheat, barley, rye, oats, rice, soybean, cotton, canola, sugar beet, potatoes, tobacco, and oil seed rape, more preferably to wheat, simultaneously or sequentially.

The combinations of one or more Chloroacetanilide herbicide with one or more safeners according to the instant invention can be applied to the plants, seed of the plants and/or to the locus where the crop and weed plants are growing area under cultivation. The herbicides and safeners of said combinations can be applied simultaneously or in sequential order in both pre- as well as postemergence application.

In still another embodiment, the herbicide safener combination is formulated together and applied in pre-emergence application or post-emergence application.

In still another embodiment, the components are formulated separately and applied sequentially.

In still another embodiment, the components are formulated separately and applied sequentially, wherein safeners are applied to seeds from which crops are grown and herbicides are later applied to the soil or grown crops.

In still another embodiment, the safener is applied to the seeds or other propagation material of the crops prior to sowing or to the soil shortly after sowing in an in furrow-treatment.

In still another embodiment, the combination of one or more Chloroacetanilide herbicides selected from Propisochlor, S-metolachlor and Metolachlor and one or more safeners selected from Mefenpyr-diethyl, Isoxadifen-ethyl, Cloquintocet-mexyl, Benoxacor, Flurazole and Fluxofenim is formulated together and applied in pre-emergence application or post-emergence application to preferably to corn, wheat, barley, rye, oats, rice, soybean, cotton, canola, sugar beet, potatoes, tobacco, and oil seed rape, more preferably to wheat.

In still another embodiment, one or more Chloroacetanilide herbicides selected from Propisochlor, S-metolachlor and Metolachlor and one or more safeners selected from Mefenpyr-diethyl, Isoxadifen-ethyl, Cloquintocet-mexyl, Benoxacor, Flurazole and Fluxofenim of the herbicide safener combination are formulated separately and applied sequentially preferably to corn, wheat, barley, rye, oats, rice, soybean, cotton, canola, sugar beet, potatoes, tobacco, and oil seed rape, more preferably to wheat.

In still another embodiment, one or more safeners selected from Mefenpyr-diethyl, Isoxadifen-ethyl, Cloquintocet-mexyl, Benoxacor, Flurazole and Fluxofenim are applied to seeds of corn, wheat, barley, rye, oats, rice, soybean, cotton, canola, sugar beet, potatoes, tobacco, and oil seed rape, more preferably to seeds of wheat, from which crops are grown and one or more Chloroacetanilide herbicides selected from Propisochlor, S-metolachlor and Metolachlor are later applied to the soil or grown crops.

In still another embodiment, the safener selected from Mefenpyr-diethyl, Isoxadifen-ethyl, Cloquintocet-mexyl, Benoxacor, Flurazole and Fluxofenim is applied to the seeds or other propagation material of the crops prior to sowing or to the soil shortly after sowing in an in furrow-treatment.

In still another embodiment, the combination of Propisochlor and Mefenpyr-diethyl is formulated together and applied in pre-emergence application or post-emergence application to preferably to corn, wheat, barley, rye, oats, rice, soybean, cotton, canola, sugar beet, potatoes, tobacco, and oil seed rape, more preferably to wheat, wherein ratio of Propisochlor and Mefenpyr-diethyl is optionally from 6.4:1 to 64:1.

In still another embodiment, Mefenpyr-diethyl is applied to seeds of corn, wheat, barley, rye, oats, rice, soybean, cotton, canola, sugar beet, potatoes, tobacco, and oil seed rape, more preferably to seeds of wheat, from which crops are grown and Propisochlor is applied later to the soil or grown crops.

In still another embodiment, the combination of Propisochlor and Isoxadifen-ethyl is formulated together and applied in pre-emergence application or post-emergence application to preferably to corn, wheat, barley, rye, oats, rice, soybean, cotton, canola, sugar beet, potatoes, tobacco, and oil seed rape, more preferably to wheat, wherein ratio of Propisochlor and Isoxadifen-ethyl is optionally from 4.14:1 to 41.14:1.

In still another embodiment, Isoxadifen-ethyl is applied to seeds of corn, wheat, barley, rye, oats, rice, soybean, cotton, canola, sugar beet, potatoes, tobacco, and oil seed rape, more preferably to seeds of wheat, from which crops are grown and Propisochlor is applied later to the soil or grown crops.

In still another embodiment, the combination of Propisochlor and Cloquintocet-mexyl is formulated together and applied in pre-emergence application or post-emergence application to preferably to corn, wheat, barley, rye, oats, rice, soybean, cotton, canola, sugar beet, potatoes, tobacco, and oil seed rape, more preferably to wheat, wherein ratio of Propisochlor and Cloquintocet-mexyl is optionally from 14.4:1 to 144:1.

In still another embodiment, Cloquintocet-mexyl is applied to seeds of corn, wheat, barley, rye, oats, rice, soybean, cotton, canola, sugar beet, potatoes, tobacco, and oil seed rape, more preferably to seeds of wheat, from which crops are grown and Propisochlor is applied later to the soil or grown crops.

In still another embodiment, the combination of Propisochlor and Benoxacor is formulated together and applied in pre-emergence application or post-emergence application preferably to corn, wheat, barley, rye, oats, rice, soybean, cotton, canola, sugar beet, potatoes, tobacco, and oil seed rape, more preferably to wheat, wherein ratio of Propisochlor and Benoxacor is optionally from 9.6:1 to 19.2:1.

In still another embodiment, Benoxacor is applied to seeds of corn, wheat, barley, rye, oats, rice, soybean, cotton, canola, sugar beet, potatoes, tobacco, and oil seed rape, more preferably to seeds of wheat, from which crops are grown and Propisochlor is applied later to the soil or grown crops.

In still another embodiment, the combination of Propisochlor and Flurazole is formulated together and applied in pre-emergence application or post-emergence application preferably to corn, wheat, barley, rye, oats, rice, soybean, cotton, canola, sugar beet, potatoes, tobacco, and oil seed rape, more preferably to wheat, wherein ratio of Propisochlor and Flurazole is optionally from 24:1 to 240:1.

In still another embodiment, Flurazole is applied to seeds of corn, wheat, barley, rye, oats, rice, soybean, cotton, canola, sugar beet, potatoes, tobacco, and oil seed rape, more preferably to seeds of wheat, from which crops are grown and Propisochlor is applied later to the soil or grown crops.

In still another embodiment, the combination of Propisochlor and Fluxofenim is formulated together and applied in pre-emergence application or post-emergence application preferably to corn, wheat, barley, rye, oats, rice, soybean, cotton, canola, sugar beet, potatoes, tobacco, and oil seed rape, more preferably to wheat, wherein ratio of Propisochlor and Fluxofenim is optionally from 23.84:1 to 250.43:1.

In still another embodiment, Fluxofenim is applied to seeds of corn, wheat, barley, rye, oats, rice, soybean, cotton, canola, sugar beet, potatoes, tobacco, and oil seed rape, more preferably to seeds of wheat, from which crops are grown and Propisochlor is applied later to the soil or grown crops.

In still another embodiment, Dichlormid is applied to seeds of corn, wheat, barley, rye, oats, rice, soybean, cotton, canola, sugar beet, potatoes, tobacco, and oil seed rape, more preferably to seeds of wheat, from which crops are grown and Propisochlor is applied later to the soil or grown crops.

In still another embodiment, Fenclorim is applied to seeds of corn, wheat, barley, rye, oats, rice, soybean, cotton, canola, sugar beet, potatoes, tobacco, and oil seed rape, more preferably to seeds of wheat, from which crops are grown and Propisochlor is applied later to the soil or grown crops.

In still another embodiment, the combination of Propisochlor and Mefenpyr-diethyl is formulated together and applied in pre-emergence application or post-emergence application to preferably to corn, wheat, barley, rye, oats, rice, soybean, cotton, canola, sugar beet, potatoes, tobacco, and oil seed rape, more preferably to wheat, wherein Propisochlor is applied at the rate of 1440 g ai/ha and Mefenpyr-diethyl is applied at the rate of range from 22.5 to 225 g ai/ha, preferably at 22.5 or 225 g ai/ha.

In still another embodiment, Mefenpyr-diethyl is applied to seeds of corn, wheat, barley, rye, oats, rice, soybean, cotton, canola, sugar beet, potatoes, tobacco, and oil seed rape, more preferably to seeds of wheat, from which crops are grown and Propisochlor is applied later to the soil or grown crops, wherein Propisochlor is applied at the rate of 1440 g ai/ha and Mefenpyr-diethyl is applied at the rate of range from 22.5 to 225 g ai/ha, preferably at 22.5 or 225 g ai/ha.

In still another embodiment, the combination of Propisochlor and Isoxadifen-ethyl is formulated together and applied in pre-emergence application or post-emergence application to preferably to corn, wheat, barley, rye, oats, rice, soybean, cotton, canola, sugar beet, potatoes, tobacco, and oil seed rape, more preferably to wheat, wherein Propisochlor is applied at the rate of 1440 g ai/ha and Isoxadifen-ethyl is applied at the rate of range from 35 to 350 g ai/ha, preferably at 35 or 350 g ai/ha.

In still another embodiment, Isoxadifen-ethyl is applied to seeds of corn, wheat, barley, rye, oats, rice, soybean, cotton, canola, sugar beet, potatoes, tobacco, and oil seed rape, more preferably to seeds of wheat, from which crops are grown and Propisochlor is applied later to the soil or grown crops, wherein Propisochlor is applied at the rate of 1440 g ai/ha and Isoxadifen-ethyl is applied at the rate of 35 g ai/ha.

In still another embodiment, the combination of Propisochlor and Cloquintocet-mexyl is formulated together and applied in pre-emergence application or post-emergence application to preferably to corn, wheat, barley, rye, oats, rice, soybean, cotton, canola, sugar beet, potatoes, tobacco, and oil seed rape, more preferably to wheat, wherein Propisochlor is applied at the rate of 1440 g ai/ha and Cloquintocet-mexyl is applied at the rate of range from 10 to 100 g ai/ha, preferably at 10 or 100 g ai/ha.

In still another embodiment, Cloquintocet-mexyl is applied to seeds of corn, wheat, barley, rye, oats, rice, soybean, cotton, canola, sugar beet, potatoes, tobacco, and oil seed rape, more preferably to seeds of wheat, from which crops are grown and Propisochlor is applied later to the soil or grown crops, wherein Propisochlor is applied at the rate of 1440 g ai/ha and Cloquintocet-mexyl is applied at the rate of range from 10 to 100 g ai/ha, preferably at 10 or 100 g ai/ha.

In still another embodiment, the combination of Propisochlor and Benoxacor is formulated together and applied in pre-emergence application or post-emergence application preferably to corn, wheat, barley, rye, oats, rice, soybean, cotton, canola, sugar beet, potatoes, tobacco, and oil seed rape, more preferably to wheat, wherein Propisochlor is applied at the rate of 1440 g ai/ha and Benoxacor is applied at the rate of range from 75 to 150 g ai/ha, preferably at 75 or 150 g ai/ha.

In still another embodiment, Benoxacor is applied to seeds of corn, wheat, barley, rye, oats, rice, soybean, cotton, canola, sugar beet, potatoes, tobacco, and oil seed rape, more preferably to seeds of wheat, from which crops are grown and Propisochlor is applied later to the soil or grown crops, wherein Propisochlor is applied at the rate of 1440 g ai/ha and Benoxacor is applied at the rate of 75 g ai/ha.

In still another embodiment, the combination of Propisochlor and Flurazole is formulated together and applied in pre-emergence application or post-emergence application preferably to corn, wheat, barley, rye, oats, rice, soybean, cotton, canola, sugar beet, potatoes, tobacco, and oil seed rape, more preferably to wheat, wherein Propisochlor is applied at the rate of 1440 g ai/ha and Flurazole is applied at the rate of range from 6 to 60 g ai/ha, preferably at 6 or 60 g ai/ha.

In still another embodiment, Flurazole is applied to seeds of corn, wheat, barley, rye, oats, rice, soybean, cotton, canola, sugar beet, potatoes, tobacco, and oil seed rape, more preferably to seeds of wheat, from which crops are grown and Propisochlor is applied later to the soil or grown crops, wherein Propisochlor is applied at the rate of 1440 g ai/ha and Flurazole is applied at the rate of 60 g ai/ha.

In still another embodiment, the combination of Propisochlor and Fluxofenim is formulated together and applied in pre-emergence application or post-emergence application preferably to corn, wheat, barley, rye, oats, rice, soybean, cotton, canola, sugar beet, potatoes, tobacco, and oil seed rape, more preferably to wheat, wherein Propisochlor is applied at the rate of 1440 g ai/ha and Fluxofenim is applied at the rate of range from 5.75 to 60.4 g ai/ha, preferably at 5.75 or 60.4 g ai/ha.

In still another embodiment, Fluxofenim is applied to seeds of corn, wheat, barley, rye, oats, rice, soybean, cotton, canola, sugar beet, potatoes, tobacco, and oil seed rape, more preferably to seeds of wheat, from which crops are grown and Propisochlor is applied later to the soil or grown crops, wherein Propisochlor is applied at the rate of 1440 g ai/ha and Fluxofenim is applied at the rate of range from 6 to 60 g ai/ha, preferably at 6 or 60 g ai/ha.

In still another embodiment, Dichlormid is applied to seeds of corn, wheat, barley, rye, oats, rice, soybean, cotton, canola, sugar beet, potatoes, tobacco, and oil seed rape, more preferably to seeds of wheat, from which crops are grown and Propisochlor is applied later to the soil or grown crops, wherein Propisochlor is applied at the rate of 1440 g ai/ha and Dichlormid is applied at the rate of range from 220 to 440 g ai/ha, preferably at 220 or 440 g ai/ha.

In still another embodiment, Fenchlorim is applied to seeds of corn, wheat, barley, rye, oats, rice, soybean, cotton, canola, sugar beet, potatoes, tobacco, and oil seed rape, more preferably to seeds of wheat, from which crops are grown and Propisochlor is applied later to the soil or grown crops, wherein Propisochlor is applied at the rate of 1440 g ai/ha and Fenchlorim is applied at the rate of range from 150 to 300 g ai/ha, preferably at 150 or 300 g ai/ha.

The herbicide safener compositions of the present invention can reduce phytotoxicity of Chloroacetanilide herbicides and therefore provide selective control of weeds.

As will be demonstrated in the examples, the combinations of one or more Chloroacetanilide herbicides with one or more safeners reduced phytotoxicity of herbicides, resulted in increased height of plants and/or increased number of plants standing after treatments.

These and other advantages of the invention may become more apparent from the examples set forth herein below. These examples are provided merely as illustrations of the invention and are not intended to be construed as a limitation thereof.

### Examples

Experiments were carried out to evaluate the phytotoxicity, effect on plant height and effect on number of plants standing after treatments with combinations of one or more Chloroacetanilide herbicides with one or more safeners.

Below table gives summary of the formulation details and application details of Propisochlor and Mefenpyr-diethyl, Isoxadifen-ethyl and Cloquintocet-mexyl that were used in combination with Propisochlor for treatments. Application method was spray and applications were made to soil.

TABLE 1

| Treatment | Treatment | Formulation | Application |
|---|---|---|---|
| Number | components | details | details |
| 1a | Untreated check | — | — |
| 2a | Propisochlor | 720 g/L EC | 1440 g ai/ha |
| 3a | Propisochlor + | 720 g/L EC + | 1440 g ai/ha + |
| | Mefenpyr-diethyl | 450 g/L EC | 22.5 g ai/ha |
| 4a | Propisochlor + | 720 g/L EC + | 1440 g ai/ha + |
| | Mefenpyr-diethyl | 450 g/L EC | 225 g ai/ha |
| 5a | Propisochlor + | 720 g/L EC + | 1440 g ai/ha + |
| | Isoxadifen-ethyl | 82 g/L EC | 35 g ai/ha |
| 6a | Propisochlor + | 720 g/L EC + | 1440 g ai/ha + |
| | Isoxadifen-ethyl | 82 g/L EC | 350 g ai/ha |
| 7a | Propisochlor + | 720 g/L EC + | 1440 g ai/ha + |
| | Cloquintocet-mexyl | 160 g/L EC | 10 g ai/ha |
| 8a | Propisochlor + | 720 g/L EC + | 1440 g ai/ha + |
| | Cloquintocet-mexyl | 160 g/L EC | 100 g ai/ha |

Below table gives summary of the formulation details and application details of Propisochlor and Dichlormid, Fenclorim, Benoxacor, Flurazole and Fluxofenim that were used in combination with Propisochlor for treatments. Application method was spray and applications were made to soil.

TABLE 2

| Treatment | Treatment | Formulation | Application |
|---|---|---|---|
| Number | components | details | details |
| 9a | Untreated check | — | — |
| 10a | Propisochlor | 720 g/L EC | 1440 g ai/ha |
| 11a | Propisochlor + | 720 g/L EC + | 1440 g ai/ha + |
| | Dichlormid | 450 g/L EC | 220 g ai/ha |
| 12a | Propisochlor + | 720 g/L EC + | 1440 g ai/ha + |
| | Dichlormid | 450 g/L EC | 440 g ai/ha |
| 13a | Propisochlor + | 720 g/L EC + | 1440 g ai/ha + |
| | Fenclorim | 220 g/L EC | 150 g ai/ha |
| 14a | Propisochlor + | 720 g/L EC + | 1440 g ai/ha + |
| | Fenclorim | 220 g/L EC | 300 g ai/ha |
| 15a | Propisochlor + | 720 g/L EC + | 1440 g ai/ha + |
| | Benoxacor | 160 g/L EC | 75 g ai/ha |
| 16a | Propisochlor + | 720 g/L EC + | 1440 g ai/ha + |
| | Benoxacor | 160 g/L EC | 150 g ai/ha |
| 17a | Propisochlor + | 720 g/L EC + | 1440 g ai/ha + |
| | Flurazole | 400 g/Kg WP | 6 g ai/ha |
| 18a | Propisochlor + | 720 g/L EC + | 1440 g ai/ha + |
| | Flurazole | 400 g/Kg WP | 60 g ai/ha |
| 19a | Propisochlor + | 720 g/L EC + | 1440 g ai/ha + |
| | Fluxofenim | 958 g/L EC | 5.75 g ai/ha |
| 20a | Propisochlor + | 720 g/L EC + | 1440 g ai/ha + |
| | Fluxofenim | 958 g/L EC | 60.4 g ai/ha |

Below table gives summary of % weed control shown by untreated check, Propisochlor alone and combination of Propisochlor with Mefenpyr-diethyl, Isoxadifen-ethyl and Cloquintocet-mexyl at different application rates. % weed control was checked for weed Lolium multiflorum.

TABLE 3

| | | | % Weed Control | | | | |
|---|---|---|---|---|---|---|---|
| Treatment | Treatment | Application | 7 | 14 | 21 | 28 | 35 |
| Number | components | details | DAA * | DAA * | DAA * | DAA * | DAA * |
| 1a | Untreated | — | 0 | 0 | 0 | 0 | 0 |
| | check | | | | | | |
| 2a | Propisochlor | 1440 g ai/ha | 100 | 100 | 100 | 100 | 100 |
| 3a | Propisochlor + | 1440 g ai/ha + | 100.0 | 98.8 | 96.3 | 97.3 | 95.0 |
| | Mefenpyr-diethyl | 22.5 g ai/ha | | | | | |
| 4a | Propisochlor + | 1440 g ai/ha + | 100.0 | 97.5 | 97.5 | 98.8 | 98.3 |
| | Mefenpyr-diethyl | 225 g ai/ha | | | | | |
| 5a | Propisochlor + | 1440 g ai/ha + | 100.0 | 100.0 | 99.3 | 98.8 | 97.5 |
| | Isoxadifen-ethyl | 35 g ai/ha | | | | | |
| 6a | Propisochlor + | 1440 g ai/ha + | 100.0 | 98.8 | 98.8 | 99.5 | 99.0 |
| | Isoxadifen-ethyl | 350 g ai/ha | | | | | |
| 7a | Propisochlor + | 1440 g ai/ha + | 100.0 | 99.3 | 98.8 | 97.3 | 96.0 |
| | Cloquintocet-mexyl | 10.1 g ai/ha | | | | | |
| 8a | Propisochlor + | 1440 g ai/ha + | 100.0 | 100.0 | 99.5 | 99.5 | 98.8 |
| | Cloquintocet-mexyl | 100 g ai/ha | | | | | |

* DAA- Days after administration. All the values for % weed control in table above are average of 4 replications.

Below table gives summary of % weed control shown by untreated check, Propisochlor alone and combination of Propisochlor with Dichlormid, Fenclorim, Benoxacor, Flurazole and Fluxofenim at different application rates. % weed control was checked for weed Lolium multiflorum.

TABLE 4

| | | | % Weed Control | | | | |
|---|---|---|---|---|---|---|---|
| Treatment | Treatment | Application | 7 | 14 | 21 | 28 | 35 |
| Number | components | details | DAA * | DAA * | DAA * | DAA * | DAA * |
| 9a | Untreated | — | 0 | 0 | 0 | 0 | 0 |
| | check | | | | | | |
| 10a | Propisochlor | 1440 g ai/ha | 100.0 | 100.0 | 100.0 | 99.3 | 99.0 |
| 11a | Propisochlor + | 1440 g ai/ha + | 100.0 | 100.0 | 100.0 | 100.0 | 100.0 |
| | Dichlormid | 220 g ai/ha | | | | | |
| 12a | Propisochlor + | 1440 g ai/ha + | 100.0 | 100.0 | 100.0 | 100.0 | 100.0 |
| | Dichlormid | 440 g ai/ha | | | | | |
| 13a | Propisochlor + | 1440 g ai/ha + | 100.0 | 100.0 | 100.0 | 100.0 | 100.0 |
| | Fenclorim | 150 g ai/ha | | | | | |
| 14a | Propisochlor + | 1440 g ai/ha + | 100.0 | 100.0 | 100.0 | 100.0 | 99.0 |
| | Fenclorim | 300 g ai/ha | | | | | |
| 15a | Propisochlor + | 1440 g ai/ha + | 100.0 | 100.0 | 100.0 | 98.3 | 97.0 |
| | Benoxacor | 75 g ai/ha | | | | | |
| 16a | Propisochlor + | 1440 g ai/ha + | 100.0 | 100.0 | 100.0 | 100.0 | 100.0 |
| | Benoxacor | 150 g ai/ha | | | | | |
| 17a | Propisochlor + | 1440 g ai/ha + | 100.0 | 100.0 | 100.0 | 99.0 | 97.0 |
| | Flurazole | 6 g ai/ha | | | | | |
| 18a | Propisochlor + | 1440 g ai/ha + | 100.0 | 100.0 | 100.0 | 99.5 | 98.3 |
| | Flurazole | 60 g ai/ha | | | | | |
| 19a | Propisochlor + | 1440 g ai/ha + | 100.0 | 100.0 | 98.8 | 100.0 | 100.0 |
| | Fluxofenim | 5.75 g ai/ha | | | | | |
| 20a | Propisochlor + | 1440 g ai/ha + | 100.0 | 100.0 | 100.0 | 99.0 | 96.5 |
| | Fluxofenim | 60.4 g ai/ha | | | | | |

* DAA- Days after administration. All the values for % weed control in table above are average of 4 replications.

Below table gives summary of % phytotoxicity in wheat crop and effect on standing plants shown by untreated check, Propisochlor alone and combination of Propisochlor with Mefenpyr-diethyl, Isoxadifen-ethyl and Cloquintocet-mexyl at different application rates.

TABLE 5

| | | | % Phytotoxicity | | | | | |
|---|---|---|---|---|---|---|---|---|
| Treatment | Treatment | Application | 7 | 14 | 21 | 28 | 35 | Plants |
| Number | components | details | DAA* | DAA* | DAA* | DAA* | DAA* | Standing |
| 1a | Untreated | — | 0 | 0 | 0 | 0 | 0 | 8.0 |
| | check | | | | | | | |
| 2a | Propisochlor | 1440 g ai/ha | 98.0 | 99.0 | 99.5 | 99.5 | 99.0 | 0.5 |
| 3a | Propisochlor + | 1440 g ai/ha + | 96.5 | 88.8 | 87.5 | 87.5 | 85.5 | 2.3 |
| | Mefenpyr-diethyl | 22.5 g ai/ha | | | | | | |
| 4a | Propisochlor + | 1440 g ai/ha + | 95.0 | 87.5 | 85.0 | 81.3 | 78.8 | 3.5 |
| | Mefenpyr-diethyl | 225 g ai/ha | | | | | | |
| 5a | Propisochlor + | 1440 g ai/ha + | 96.8 | 96.0 | 96.0 | 96.0 | 96.0 | 1.5 |
| | Isoxadifen-ethyl | 35 g ai/ha | | | | | | |
| 6a | Propisochlor + | 1440 g ai/ha + | 96.3 | 94.8 | 94.0 | 94.0 | 92.0 | 1.8 |
| | Isoxadifen-ethyl | 350 g ai/ha | | | | | | |
| 7a | Propisochlor + | 1440 g ai/ha + | 97.3 | 98.3 | 97.8 | 97.8 | 95.8 | 1.0 |
| | Cloquintocet-mexyl | 10.1 g ai/ha | | | | | | |
| 8a | Propisochlor + | 1440 g ai/ha + | 95.5 | 94.3 | 92.0 | 88.8 | 86.3 | 2.5 |
| | Cloquintocet-mexyl | 100 g ai/ha | | | | | | |

*DAA- Days after administration. All the values for % phytotoxicity in table above are average of 4 replications.

It is evident from above table that combinations of Propisochlor with all of three safeners i.e. Mefenpyr-diethyl, Isoxadifen-ethyl and Cloquintocet-mexyl at both application rates exhibited less phytotoxicity as compared to single Propisochlor treatment. It is also evident from the above table that combinations of Propisochlor with all of three safeners at both application rates resulted in increase in plant height as compared to single Propisochlor treatment.

Below table gives summary of % phytotoxicity in wheat crop shown by untreated check, Propisochlor alone and combination of Propisochlor with Dichlormid, Fenclorim, Benoxacor, Flurazole and Fluxofenim at different application rates.

TABLE 6

| | | | % Phytotoxicity | | | | | |
|---|---|---|---|---|---|---|---|---|
| Treatment | Treatment | Application | 7 | 14 | 21 | 28 | 35 | Plants |
| No. | components | details | DAA* | DAA* | DAA* | DAA* | DAA* | Standing |
| 9a | Untreated | — | 0 | 0 | 0 | 0 | 0 | 8.3 |
| | check | | | | | | | |
| 10a | Propisochlor | 1440 g ai/ha | 99.5 | 100 | 100 | 100 | 100 | 0.0 |
| 11a | Propisochlor + | 1440 g ai/ha + | 98.8 | 99.5 | 100 | 100 | 100 | 0.0 |
| | Dichlormid | 220 g ai/ha | | | | | | |
| 12a | Propisochlor + | 1440 g ai/ha + | 98.0 | 99.3 | 100 | 100 | 100 | 0.0 |
| | Dichlormid | 440 g ai/ha | | | | | | |
| 13a | Propisochlor + | 1440 g ai/ha + | 98.3 | 99.0 | 99.5 | 100 | 100.0 | 0.3 |
| | Fenclorim | 150 g ai/ha | | | | | | |
| 14a | Propisochlor + | 1440 g ai/ha + | 98.5 | 99.5 | 100.0 | 98.8 | 98.8 | 0.3 |
| | Fenclorim | 300 g ai/ha | | | | | | |
| 15a | Propisochlor + | 1440 g ai/ha + | 97.0 | 98.5 | 99.3 | 98.3 | 98.5 | 0.5 |
| | Benoxacor | 75 g ai/ha | | | | | | |
| 16a | Propisochlor + | 1440 g ai/ha + | 98.0 | 98.3 | 98.8 | 98.3 | 97.5 | 0.5 |
| | Benoxacor | 150 g ai/ha | | | | | | |
| 17a | Propisochlor + | 1440 g ai/ha + | 98.0 | 98.5 | 98.8 | 98.0 | 97.0 | 0.5 |
| | Flurazole | 6 g ai/ha | | | | | | |
| 18a | Propisochlor + | 1440 g ai/ha + | 98.5 | 99.3 | 99.8 | 99.5 | 99.5 | 0.3 |
| | Flurazole | 60 g ai/ha | | | | | | |
| 19a | Propisochlor + | 1440 g ai/ha + | 97.0 | 99.3 | 98.8 | 99.3 | 99.0 | 0.3 |
| | Fluxofenim | 5.75 g ai/ha | | | | | | |
| 20a | Propisochlor + | 1440 g ai/ha + | 99.0 | 99.0 | 99.0 | 98.8 | 97.5 | 0.5 |
| | Fluxofenim | 60.4 g ai/ha | | | | | | |

*DAA- Days after administration. All the values for % phytotoxicity in table above are average of 4 replications.

It is evident from above table that combinations of Propisochlor with Benoxacor, Flurazole and Fluxofenim at both application rates exhibited less phytotoxicity as compared to single Propisochlor treatment. However, it is also evident from above table that combinations of Propisochlor with Dichlormid and Fenclorim at both application rates exhibited similar phytotoxicity as compared to single Propisochlor treatment and resulted in killing of plant.

It is also evident from the above table that combinations of Propisochlor with all of five safeners except Dichlormid at both application rates resulted in increase in plant height as compared to single Propisochlor treatment.

Below table gives summary of the formulation details and application details of Fipronil alone, Propisochlor+Fipronil and Mefenpyr-diethyl, Isoxadifen-ethyl and Cloquintocet-mexyl that were used for treatment seeds from which crops were grown. Mode of application for herbicides was spray and they were applied to soil after sowing of untreated seeds or seeds treated with safeners.

TABLE 7

| Treatment | Treatment | Formulation | Application |
|---|---|---|---|
| Number | components | details | details |
| 1b | Fipronil | 250 g/L FS | 25 g ai/100 kg |
| 2b | Fipronil + | 250 g/L FS + | 25 g ai/100 kg + |
| | Propisochlor | 720 g/L EC | 1440 g ai/ha |
| 3b | Fipronil + | 250 g/L FS + | 25 g ai/100 kg + |
| | Propisochlor + | 720 g/L EC + | 1440 g ai/ha + |
| | Mefenpyr-diethyl | 450 g/L EC | 22.5 g ai/100 kg |
| 4b | Fipronil + | 250 g/L FS + | 25 g ai/100 kg + |
| | Propisochlor + | 720 g/L EC + | 1440 g ai/ha + |
| | Mefenpyr-diethyl | 450 g/L EC | 225 g ai/100 kg |
| 5b | Fipronil + | 250 g/L FS + | 25 g ai/100 kg + |
| | Propisochlor + | 720 g/L EC + | 1440 g ai/ha + |
| | Isoxadifen-ethyl | 82 g/L EC | 35 g ai/100 kg |
| 6b | Fipronil + | 250 g/L FS + | 25 g ai/100 kg + |
| | Propisochlor + | 720 g/L EC + | 1440 g ai/ha + |
| | Isoxadifen-ethyl | 82 g/L EC | 350 g ai/100 kg |
| 7b | Fipronil + | 250 g/L FS + | 25 g ai/100 kg + |
| | Propisochlor + | 720 g/L EC + | 1440 g ai/ha + |
| | Cloquintocet-mexyl | 160 g/L EC | 10.1 g ai/100 kg |
| 8b | Fipronil + | 250 g/L FS + | 25 g ai/100 kg + |
| | Propisochlor + | 720 g/L EC + | 1440 g ai/ha + |
| | Cloquintocet-mexyl | 160 g/L EC | 100 g ai/100 kg |

Below table gives summary of the formulation details and application details of Fipronil alone, Propisochlor+Fipronil and Dichlormid, Fenclorim, Benoxacor, Flurazole and Fluxofenim that were used for treatment of seeds from which crops were grown. Mode of application for herbicides was spray and they were applied to soil after sowing of untreated seeds or seeds treated with safeners.

TABLE 8

| Treatment | Treatment | Formulation | Application |
|---|---|---|---|
| Number | components | details | details |
| 9b | Fipronil | 250 g/L FS | 25 g ai/100 kg |
| 10b | Fipronil + | 250 g/L FS + | 25 g ai/100 kg + |
| | Propisochlor | 720 g/L EC | 1440 g ai/ha |
| 11b | Fipronil + | 250 g/L FS + | 25 g ai/100 kg + |
| | Propisochlor + | 720 g/L EC + | 1440 g ai/ha + |
| | Dichlormid | 450 g/L EC | 220 g ai/100 kg |
| 12b | Fipronil + | 250 g/L FS + | 25 g ai/100 kg + |
| | Propisochlor + | 720 g/L EC + | 1440 g ai/ha + |
| | Dichlormid | 450 g/L EC | 440 g ai/100 kg |
| 13b | Fipronil + | 250 g/L FS + | 25 g ai/100 kg + |
| | Propisochlor + | 720 g/L EC + | 1440 g ai/ha + |
| | Fenclorim | 220 g/L EC | 150 g ai/100 kg |
| 14b | Fipronil + | 250 g/L FS + | 25 g ai/100 kg + |
| | Propisochlor + | 720 g/L EC + | 1440 g ai/ha + |
| | Fenclorim | 220 g/L EC | 300 g ai/100 kg |
| 15b | Fipronil + | 250 g/L FS + | 25 g ai/100 kg + |
| | Propisochlor + | 720 g/L EC + | 1440 g ai/ha + |
| | Benoxacor | 160 g/L EC | 75 g ai/100 kg |
| 16b | Fipronil + | 250 g/L FS + | 25 g ai/100 kg + |
| | Propisochlor + | 720 g/L EC + | 1440 g ai/ha + |
| | Benoxacor | 160 g/L EC | 150 g ai/100 kg |
| 17b | Fipronil + | 250 g/L FS + | 25 g ai/100 kg + |
| | Propisochlor + | 720 g/L EC + | 1440 g ai/ha + |
| | Flurazole | 400 g/L WP | 6 g ai/100 kg |
| 18b | Fipronil + | 250 g/L FS + | 25 g ai/100 kg + |
| | Propisochlor + | 720 g/L EC + | 1440 g ai/ha + |
| | Flurazole | 400 g/L WP | 60 g ai/100 kg |
| 19b | Fipronil + | 250 g/L FS + | 25 g ai/100 kg + |
| | Propisochlor + | 720 g/L EC + | 1440 g ai/ha + |
| | Fluxofenim | 958 g/L EC | 6 g ai/100 kg |
| 20b | Fipronil + | 250 g/L FS + | 25 g ai/100 kg + |
| | Propisochlor + | 720 g/L EC + | 1440 g ai/ha + |
| | Fluxofenim | 958 g/L EC | 60 g ai/100 kg |

Below table gives summary of % phytotoxicity in wheat crop shown by Fipronil alone, Propisochlor+Fipronil on the crops grown from untreated seeds and Propisochlor+Fipronil on the crops grown from seeds treated by either of Mefenpyr-diethyl, Isoxadifen-ethyl and Cloquintocet-mexyl.

TABLE 9

| | | | % Phytotoxicity | | | | |
|---|---|---|---|---|---|---|---|
| Treatment | Treatment | Application | 7 | 14 | 21 | 28 | 35 |
| Number | components | details | DAA | DAA | DAA | DAA | DAA |
| 1b | Fipronil | 25 g ai/100 kg | 0 | 0 | 0 | 0 | 0 |
| 2b | Fipronil + | 25 g ai/100 kg + | 90.0 | 90.5 | 86.8 | 83.5 | 75.0 |
| | Propisochlor | 1440 g ai/ha | | | | | |
| 3b | Fipronil + | 25 g ai/100 kg + | 38.8 | 35.8 | 25.0 | 20.8 | 13.3 |
| | Propisochlor + | 1440 g ai/ha + | | | | | |
| | Mefenpyr-diethyl | 22.5 g ai/100 kg | | | | | |
| 4b | Fipronil + | 25 g ai/100 kg + | 51.3 | 47.8 | 44.3 | 39.3 | 33.3 |
| | Propisochlor + | 1440 g ai/ha + | | | | | |
| | Mefenpyr-diethyl | 225 g ai/100 kg | | | | | |
| 5b | Fipronil + | 25 g ai/100 kg + | 85.0 | 84.0 | 83.3 | 79.3 | 73.8 |
| | Propisochlor + | 1440 g ai/ha + | | | | | |
| | Isoxadifen-ethyl | 35 g ai/100 kg | | | | | |
| 6b | Fipronil + | 25 g ai/100 kg + | 94.3 | 95.3 | 95.3 | 94.0 | 93.5 |
| | Propisochlor + | 1440 g ai/ha + | | | | | |
| | Isoxadifen-ethyl | 350 g ai/100 kg | | | | | |
| 7b | Fipronil + | 25 g ai/100 kg + | 42.5 | 40.0 | 27.5 | 23.3 | 14.0 |
| | Propisochlor + | 1440 g ai/ha + | | | | | |
| | Cloquintocet-mexyl | 10.1 g ai/100 kg | | | | | |
| 8b | Fipronil + | 25 g ai/100 kg + | 47.5 | 45.0 | 39.5 | 35.5 | 23.8 |
| | Propisochlor + | 1440 g ai/ha + | | | | | |
| | Cloquintocet-mexyl | 100 g ai/100 kg | | | | | |

* DAA- Days after administration. All the values for % phytotoxicity in table above are average of 4 replications.

It is evident from above table that treatments of Propisochlor+Fipronil at both application rates on the crops grown from seeds treated with Mefenpyr-diethyl, at both application rates on the crops grown from seeds treated with Cloquintocet-mexyl and at lower application rate on the crops grown from seeds treated with Isoxadifen-ethyl exhibited less phytotoxicity as compared to crops the grown from untreated seeds. However, treatments of Propisochlor+Fipronil at higher application rate on the crops grown from seeds treated with Isoxadifen-ethyl exhibited more phytotoxicity as compared to crops the grown from untreated seeds.

Below table gives summary of % phytotoxicity in wheat crop shown by Fipronil alone, Propisochlor+Fipronil on the crops grown from untreated seeds and Propisochlor+Fipronil on the crops grown from seeds treated by either of Dichlormid, Fenclorim, Benoxacor, Flurazole and Fluxofenim.

TABLE 10

| | | | % Phytotoxicity | | | | |
|---|---|---|---|---|---|---|---|
| Treatment | Treatment | Application | 8 | 15 | 22 | 29 | 36 |
| Number | components | details | DAA | DAA | DAA | DAA | DAA |
| 9b | Fipronil | 25 g ai/100 kg | 0 | 0 | 0 | 0 | 0 |
| 10b | Fipronil + | 25 g ai/100 kg + | 96.5 | 96.0 | 95.0 | 92.3 | 91.5 |
| | Propisochlor | 1440 g ai/ha | | | | | |
| 11b | Fipronil + | 25 g ai/100 kg + | 92.0 | 90.3 | 86.3 | 84.5 | 78.8 |
| | Propisochlor + | 1440 g ai/ha + | | | | | |
| | Dichlormid | 220 g ai/100 kg | | | | | |
| 12b | Fipronil + | 25 g ai/100 kg + | 90.8 | 90.0 | 85.0 | 82.8 | 78.0 |
| | Propisochlor + | 1440 g ai/ha + | | | | | |
| | Dichlormid | 440 g ai/100 kg | | | | | |
| 13b | Fipronil + | 25 g ai/100 kg + | 94.0 | 93.0 | 90.8 | 88.3 | 85.3 |
| | Propisochlor + | 1440 g ai/ha + | | | | | |
| | Fenclorim | 150 g ai/100 kg | | | | | |
| 14b | Fipronil + | 25 g ai/100 kg + | 96.3 | 94.8 | 93.5 | 91.3 | 90.0 |
| | Propisochlor + | 1440 g ai/ha + | | | | | |
| | Fenclorim | 300 g ai/100 kg | | | | | |
| 15b | Fipronil + | 25 g ai/100 kg + | 93.0 | 90.8 | 89.5 | 87.0 | 84.5 |
| | Propisochlor + | 1440 g ai/ha + | | | | | |
| | Benoxacor | 75 g ai/100 kg | | | | | |
| 16b | Fipronil + | 25 g ai/100 kg + | 97.8 | 99.0 | 99.0 | 98.8 | 98.8 |
| | Propisochlor + | 1440 g ai/ha + | | | | | |
| | Benoxacor | 150 g ai/100 kg | | | | | |
| 17b | Fipronil + | 25 g ai/100 kg + | 97.5 | 96.3 | 96.0 | 93.3 | 90.8 |
| | Propisochlor + | 1440 g ai/ha + | | | | | |
| | Flurazole | 6 g ai/100 kg | | | | | |
| 18b | Fipronil + | 25 g ai/100 kg + | 95.0 | 94.8 | 92.3 | 90.3 | 85.3 |
| | Propisochlor + | 1440 g ai/ha + | | | | | |
| | Flurazole | 60 g ai/100 kg | | | | | |
| 19b | Fipronil + | 25 g ai/100 kg + | 48.8 | 45.0 | 40.3 | 34.5 | 30.0 |
| | Propisochlor + | 1440 g ai/ha + | | | | | |
| | Fluxofenim | 6 g ai/100 kg | | | | | |
| 20b | Fipronil + | 25 g ai/100 kg + | 38.8 | 33.8 | 28.3 | 25.3 | 19.0 |
| | Propisochlor + | 1440 g ai/ha + | | | | | |
| | Fluxofenim | 60 g ai/100 kg | | | | | |

* DAA- Days after administration. All the values for % phytotoxicity in table above are average of 4 replications.

It is evident from above table that treatments of Propisochlor+Fipronil at both application rates on the crops grown from seeds treated with Dichlormid, at both application rates on the crops grown from seeds treated with Fluxofenim and at both application rates on the crops grown from seeds treated with Fenclorim, at lower application rate on the crops grown from seeds treated with Benoxacor, and at higher application rate on the crops grown from seeds treated with Flurazole exhibited less phytotoxicity as compared to Propisochlor+Fipronil. However, treatments of Propisochlor+Fipronil at higher application rate on the crops grown from seeds treated with Benoxacor, at lower application rate on the crops grown from seeds treated with Flurazole exhibited more phytotoxicity as compared to crops the grown from untreated seeds.

Below table gives summary of effect on plant height of wheat crop and standing plants shown by Fipronil alone, Propisochlor+Fipronil on the crops grown from untreated seeds and Propisochlor+Fipronil on the crops grown from seeds treated by either of Mefenpyr-diethyl, Isoxadifen-ethyl and Cloquintocet-mexyl.

TABLE 11

| | | | Plant Height | | Standing Plants | |
|---|---|---|---|---|---|---|
| Treatment | Treatment | Application | 15 | 29 | 15 | 29 |
| Number | components | details | DAA | DAA | DAA | DAA |
| 1b | Fipronil | 25 g ai/100 kg | 10.8 | 10.8 | 22.5 | 33.8 |
| 2b | Fipronil + | 25 g ai/100 kg + | 6.3 | 6.0 | 9.3 | 29.8 |
| | Propisochlor | 1440 g ai/ha | | | | |
| 3b | Fipronil + | 25 g ai/100 kg + | 9.5 | 9.5 | 19.5 | 34.0 |
| | Propisochlor + | 1440 g ai/ha + | | | | |
| | Mefenpyr-diethyl | 22.5 g ai/100 kg | | | | |
| 4b | Fipronil + | 25 g ai/100 kg + | 6.8 | 6.8 | 20.5 | 34.5 |
| | Propisochlor + | 1440 g ai/ha + | | | | |
| | Mefenpyr-diethyl | 225 g ai/100 kg | | | | |
| 5b | Fipronil + | 25 g ai/100 kg + | 4.5 | 4.3 | 15.0 | 33.3 |
| | Propisochlor + | 1440 g ai/ha + | | | | |
| | Isoxadifen-ethyl | 35 g ai/100 kg | | | | |
| 6b | Fipronil + | 25 g ai/100 kg + | 1.5 | 1.8 | 10.3 | 30.0 |
| | Propisochlor + | 1440 g ai/ha + | | | | |
| | Isoxadifen-ethyl | 350 g ai/100 kg | | | | |
| 7b | Fipronil + | 25 g ai/100 kg + | 10.0 | 10.0 | 19.0 | 33.8 |
| | Propisochlor + | 1440 g ai/ha + | | | | |
| | Cloquintocet-mexyl | 10.1 g ai/100 kg | | | | |
| 8b | Fipronil + | 25 g ai/100 kg + | 8.3 | 8.3 | 18.3 | 34.5 |
| | Propisochlor + | 1440 g ai/ha + | | | | |
| | Cloquintocet-mexyl | 100 g ai/100 kg | | | | |

* DAA- Days after administration. All the values for plant height and standing plants in table above are average of 4 replications.

It is evident from above table that treatments of Propisochlor+Fipronil at both application rates on the crops grown from seeds treated with Mefenpyr-diethyl and at both application rates on the crops grown from seeds treated with Cloquintocet-mexyl resulted in increase in plant height as compared to as compared to crops the grown from untreated seeds.

However, treatments of Propisochlor+Fipronil at both application rates on the crops grown from seeds treated with Isoxadifen-ethyl resulted in decrease in plant height as compared to crops the grown from untreated seeds.

It is evident from above table that treatments of Propisochlor+Fipronil at both application rates on the crops grown from seeds treated with Mefenpyr-diethyl, at both application rates on the crops grown from seeds treated with Isoxadifen-ethyl and at both application rates on the crops grown from seeds treated with Cloquintocet-mexyl resulted in increase in number of standing plants as compared to crops the grown from untreated seeds.

Below table gives summary of effect on plant height and standing plants shown by Fipronil alone, Propisochlor+Fipronil on the crops grown from untreated seeds and Propisochlor+Fipronil on the crops grown from seeds treated by either of Dichlormid, Fenclorim, Benoxacor, Flurazole and Fluxofenim.

TABLE 12

| | | | Standing Plants | | Plant height | |
|---|---|---|---|---|---|---|
| Treatment | Treatment | Application | 15 | 29 | 15 | 29 |
| Number | components | details | DAA | DAA | DAA | DAA |
| 9b | Fipronil | 25 g ai/100 kg | 10.8 | 10.8 | 23.3 | 34.3 |
| 10b | Fipronil + | 25 g ai/100 kg + | 3.5 | 3.3 | 4.0 | 25.0 |
| | Propisochlor | 1440 g ai/ha | | | | |
| 11b | Fipronil + | 25 g ai/100 kg + | 5.8 | 4.5 | 9.8 | 28.8 |
| | Propisochlor + | 1440 g ai/ha + | | | | |
| | Dichlormid | 220 g ai/100 kg | | | | |
| 12b | Fipronil + | 25 g ai/100 kg + | 4.5 | 3.8 | 10.0 | 29.5 |
| | Propisochlor + | 1440 g ai/ha + | | | | |
| | Dichlormid | 440 g ai/100 kg | | | | |
| 13b | Fipronil + | 25 g ai/100 kg + | 3.8 | 3.5 | 6.3 | 28.0 |
| | Propisochlor + | 1440 g ai/ha + | | | | |
| | Fenclorim | 150 g ai/100 kg | | | | |
| 14b | Fipronil + | 25 g ai/100 kg + | 2.5 | 2.5 | 8.3 | 30.0 |
| | Propisochlor + | 1440 g ai/ha + | | | | |
| | Fenclorim | 300 g ai/100 kg | | | | |
| 15b | Fipronil + | 25 g ai/100 kg + | 3.0 | 3.0 | 10.0 | 30.0 |
| | Propisochlor + | 1440 g ai/ha + | | | | |
| | Benoxacor | 75 g ai/100 kg | | | | |
| 16b | Fipronil + | 25 g ai/100 kg + | 0.3 | 0.3 | 2.8 | 8.5 |
| | Propisochlor + | 1440 g ai/ha + | | | | |
| | Benoxacor | 150 g ai/100 kg | | | | |
| 17b | Fipronil + | 25 g ai/100 kg + | 3.8 | 3.0 | 6.0 | 25.8 |
| | Propisochlor + | 1440 g ai/ha + | | | | |
| | Flurazole | 6 g ai/100 kg | | | | |
| 18b | Fipronil + | 25 g ai/100 kg + | 2.8 | 2.8 | 5.8 | 18.0 |
| | Propisochlor + | 1440 g ai/ha + | | | | |
| | Flurazole | 60 g ai/100 kg | | | | |
| 19b | Fipronil + | 25 g ai/100 kg + | 10.5 | 10.5 | 14.8 | 33.3 |
| | Propisochlor + | 1440 g ai/ha + | | | | |
| | Fluxofenim | 6 g ai/100 kg | | | | |
| 20b | Fipronil + | 25 g ai/100 kg + | 9.3 | 9.3 | 19.8 | 36.0 |
| | Propisochlor + | 1440 g ai/ha + | | | | |
| | Fluxofenim | 60 g ai/100 kg | | | | |

* DAA- Days after administration. All the values for plant height and standing plants in table above are average of 4 replications.

It is evident from above table that treatments of Propisochlor+Fipronil at both application rates on the crops grown from seeds treated with Dichlormid, at both application rates on the crops grown from seeds treated with Fluxofenim and at lower application rate on the crops grown from seeds treated with Fenclorim resulted in increase in plant height as compared to crops the grown from untreated seeds.

It is evident from above table that treatments of Propisochlor+Fipronil at higher application rate on the crops grown from seeds treated with Fenclorim, at both application rates on the crops grown from seeds treated with Benoxacor and at both application rates on the crops grown from seeds treated with Flurazole resulted in decrease in plant height as compared to crops the grown from untreated seeds.

It is evident from above table that treatments of Propisochlor+Fipronil at both application rates on the crops grown from seeds treated with Dichlormid, at both application rates on the crops grown from seeds treated with Fluxofenim, at both application rates on the crops grown from seeds treated with Fenclorim, at lower application rate on the crops grown from seeds treated with Benoxacor and at lower application rate on the crops grown from seeds treated with Flurazole resulted in increase in plant height as compared to crops the grown from untreated seeds.

It is also evident from above table that treatments of Propisochlor+Fipronil at higher application rate on the crops grown from seeds treated with Benoxacor and at higher application rate on the crops grown from seeds treated with Flurazole resulted in decrease in plant height as compared to crops the grown from untreated seeds.

1. A herbicide combination comprising:
a. one or more chloroacetanilide herbicides; and
b. at least one safener.

2. The combination as claim 1 wherein said safener is selected from mefenpyr-deithyl, isoxadifen-ethyl, cloquintocet-mexyl, dichlormid, benoxacor, fenclorim, flurazole, fluxofenim, and combinations thereof.

3. A method of controlling weeds at a locus comprising applying herbicide combination of one or more chloroacetanilide herbicides and at least one safener to the locus.
